(19) United States
(12) Patent Application Publication
(10) Pub. No.: US 2018/0302600 A1
(43) Pub. Date: Oct. 18, 2018

(54) Determining the Condition of a Plenoptic Imaging System Using Related Views

(71) Applicants: Krishna Prasad Agara Venkatesha Rao, Bangalore (IN); Srinidhi Srinivasa, Bangalore (IN)

(72) Inventors: Krishna Prasad Agara Venkatesha Rao, Bangalore (IN); Srinidhi Srinivasa, Bangalore (IN)

(73) Assignee: Ricoh Company, Ltd., Kanagawa (JP)

(21) Appl. No.: 15/485,748

(22) Filed: Apr. 12, 2017

(51) Int. Cl. H04N 13/02

(52) U.S. Cl. CPC H04N 13/0203; H04N 13/0271

(57) ABSTRACT

The condition of the plenoptic imaging system is determined using views capturing a calibration object by the plenoptic imaging system. The plenoptic imaging system accesses at least two views from the plenoptic imaging system and determines a measure of divergence from the reference condition based on the view images associated with each view. Each of the accessed views can have a known relationship when the plenoptic imaging system is in the reference condition. Based on the measure of divergence and the known relationship, the plenoptic imaging system can indicate a variation from the reference condition. The variation can indicate misalignment or degradation of the plenoptic imaging system. This determination of divergence and indication of variation from the reference condition can be included in a variety of calibration procedures.

### BACKGROUND OF THE INVENTION

### 1. Field of the Invention

This disclosure relates generally to the calibration of plenoptic imaging systems and to the determination of a plenoptic imaging system's condition.

### 2. Description of the Related Art

The plenoptic imaging system has recently received increased attention. It is finding itself in a wide variety of uses including: high-quality imaging, medical imaging, microscopy, scientific fields, and many more. More specifically, the plenoptic imaging system finds application in imaging systems that require a high degree of alignment of the plenoptic imaging system for high-quality light-field images.

However, many plenoptic imaging systems lack easy to use or integrated calibration tools. The plenoptic imaging system may degrade suddenly for example if it is dropped or over time due to normal wear and tear, and there generally is a lack of good methods to diagnose the degradation. Complex calibration techniques can be used at the manufacturer, but there generally is a lack of good calibration methods for calibration in the field.

Thus there is need for better approaches to determine the current condition of a plenoptic imaging system, for example in reference to a calibrated reference condition.

### SUMMARY OF THE INVENTION

The present disclosure overcomes the limitations of the prior art by determining the condition of the plenoptic imaging system using images generated from the plenoptic imaging system. Preferably, the calibration determination can be performed by the system itself.

A typical plenoptic imaging system includes a microlens array and a sensor array, and the captured plenoptic image has a structure with superpixels corresponding to the microlenses. The superpixels contain different views of a calibration object. In one aspect, a condition of the plenoptic imaging system is determined using views of the calibration object captured by the plenoptic imaging system. The views would have a known relationship if the plenoptic imaging system were in a reference condition. As the views diverge from the known relationship, this indicates a divergence of the plenoptic imaging system from the reference condition. A measure of divergence from the reference condition is determined based on the divergence of the views from the known relationship.

The known relationships can be based on information about the views, the distance of a captured calibration object, the symmetry of the viewpoints from which the views were taken, and the number of plenoptic images from which the views are accessed. Depending on the known relationship, the divergence can indicate misalignment or degradation of the plenoptic imaging system. This determination of divergence and indication of variation from the reference condition can be included in a variety of calibration procedures.

Other aspects include components, devices, systems, improvements, methods, processes, applications, computer readable mediums, and other technologies related to any of the above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention has other advantages and features which will be more readily apparent from the following detailed description of the invention and the appended claims, when taken in conjunction with the accompanying drawings, in which:

FIG. 1 (prior art) is a diagram of a plenoptic imaging system.

FIG. 2 is a flow diagram for determining a condition of a plenoptic imaging system.

FIGS. 3A-3D are illustrations of a plenoptic image, a superpixel within the plenoptic image, an image of a single view, and an array of different views, respectively.

FIGS. 4A-4C illustrate a method for determining a value for a measure of divergence.

FIGS. 5A-5C each illustrates a different plenoptic image, and an array of views from that plenoptic image.

FIGS. 6A-6D illustrate pairs of views from FIGS. 5A-5C, where each pair of views has a known relationship that can be used to indicate a variation from a reference condition.

FIGS. 7A-7B illustrate a pair of views and a corresponding divergence function, for an aligned and for a misaligned plenoptic imaging system, respectively.

FIGS. 8A-8B illustrate a different pair of views and a corresponding divergence function, for an aligned and for a misaligned plenoptic imaging system, respectively.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

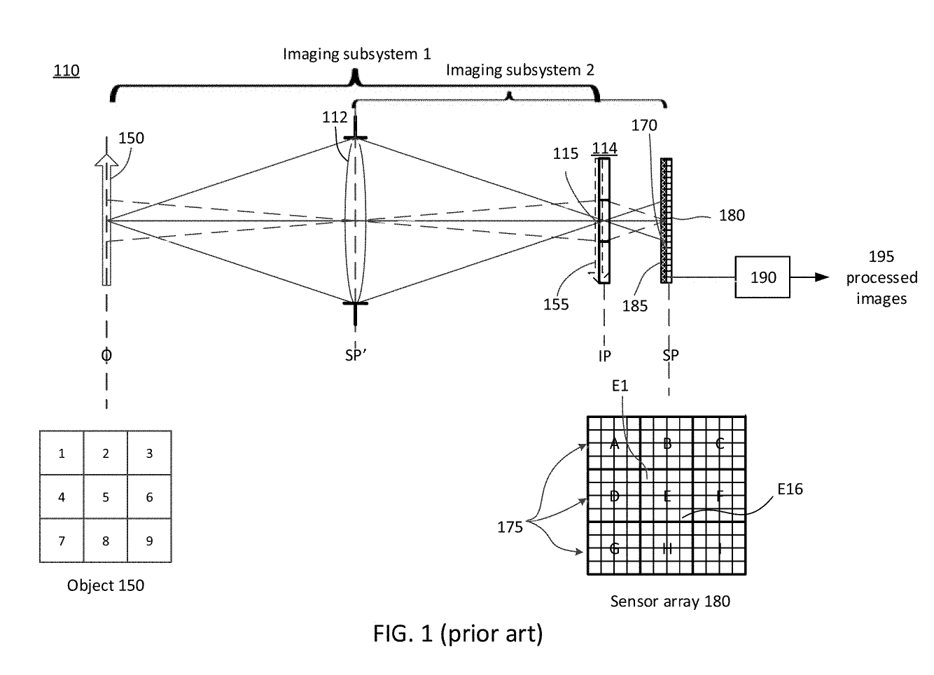

FIG. 1 (prior art) is a diagram of a plenoptic imaging system. The plenoptic imaging system 110 includes imaging optics 112 (represented by a single lens in FIG. 1), a microlens array 114 (an array of microlenses 115) and a sensor array 180. The microlens array 114 and sensor array 180 together may be referred to as a plenoptic sensor module. These components form two overlapping imaging subsystems, shown as subsystem 1 and subsystem 2 in FIG. 1.

For convenience, the imaging optics 112 is depicted in FIG. 1 as a single objective lens, but it should be understood that it could contain multiple elements. The objective lens 112 forms an optical image 155 of the object 150 at an image plane IP. The microlens array 114 is located at the image plane IP, and each microlens images the aperture of imaging subsystem 1 onto the sensor array 180. That is, the aperture and sensor array are located at conjugate planes SP and SP′. The microlens array 114 can be a rectangular array, hexagonal array or other types of arrays. The sensor array 180 is also shown in FIG. 1.

The bottom portion of FIG. 1 provides more detail. In this example, the microlens array 114 is a 3×3 array of microlenses 115. The object 150 is divided into a corresponding 3×3 array of regions, which are labeled 1-9. Each of the regions 1-9 is imaged by the imaging optics 112 and imaging subsystem 1 onto one of the microlenses 114. The dashed rays in FIG. 1 show imaging of region 5 onto the corresponding center microlens.

Each microlens 115 images these rays onto a corresponding section of the sensor array 180. The sensor array 180 is shown as a 12×12 rectangular array. The sensor array 180 can be subdivided into microlens footprints 175, labelled A-I, with each microlens footprint corresponding to one of the microlenses and therefore also corresponding to a certain region of the object 150. The image data captured by the sensors within a microlens footprint will be referred to as a superpixel.

Each superpixel 175 contains light from many individual sensors. In this example, each superpixel is generated from light from a 4×4 array of individual sensors. Each sensor for a superpixel captures light from the same region of the object, but at different propagation angles. For example, the upper left sensor E1 for superpixel E captures light from region 5, as does the lower right sensor E16 for superpixel E. However, the two sensors capture light propagating in different directions from the object. This can be seen from the solid rays in FIG. 1. All three solid rays originate from the same object point but are captured by different sensors for the same superpixel. That is because each solid ray propagates along a different direction from the object.

In other words, the object 150 generates a four-dimensional light field L(x,y,u,v), where L is the amplitude, intensity or other measure of a ray originating from spatial location (x,y) propagating in direction (u,v). Each sensor in the sensor array captures light from a certain volume of the four-dimensional light field. The sensors are sampling the four-dimensional light field. The shape or boundary of such volume is determined by the characteristics of the plenoptic imaging system. For convenience, the (x,y) region that maps to a sensor will be referred to as the light field viewing region for that sensor, and the (u,v) region that maps to a sensor will be referred to as the light field viewing direction for that sensor.

The superpixel 175 is the aggregate result of all sensors that have the same light field viewing region. The view is an analogous concept for propagation direction. The view is the aggregate result of all sensors that have the same light field viewing region. In the example of FIG. 1, the individual sensors A1, B1, C1, . . . I1 make up the upper left view of the object. The individual sensors A16, B16, C16, . . . I16 make up the lower right view of the object. The center view is the view that corresponds to (u,v)=(0,0), assuming that the plenoptic imaging system is an on-axis symmetric system. Each view is an image of the object taken from a particular viewpoint.

Because the plenoptic image 170 contains information about the four-dimensional light field produced by the object, the processing module 190 can be used to perform different types of analysis of the light-field, including analysis to determine the condition of the plenoptic imaging system.

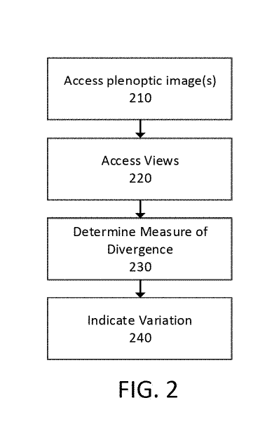

FIG. 2 is a flow diagram for determining a condition of a plenoptic imaging system from captured plenoptic images, according to one example embodiment. In this example, the current condition of the plenoptic imaging system is determined relative to a reference condition of the plenoptic imaging system. This process is explained with reference to FIGS. 2-6. In the examples described below, the process of FIG. 2 is performed by the plenoptic imaging system 110 (e.g. via the processing module 190). In another embodiment, the process is performed by a computing system separate from the plenoptic imaging system. Other modules may perform some of all of the steps of the process in other embodiments. Likewise, embodiments may include different and/or additional steps or perform the steps in differing order.

In the process of FIG. 2, the processing module 190 accesses 210 a plenoptic image of a calibration object captured by the plenoptic image system 110. Here, the calibration object is a uniformly illuminated white card, but other examples include objects without high frequency characteristics when uniformly illuminated. The plenoptic image includes an array of superpixels 175, which in the aggregate contain images (views) of the calibration object taken from different viewpoints. The processing module 190 accesses 220 views which would have a known relationship if the plenoptic imaging system were in a reference condition. The divergence of the views from the known relationship is determined 230. This is used to indicate 240 a variation of the actual condition of the plenoptic imaging system from the reference condition.

In some embodiments, the processing module can access more than one plenoptic imaging system (i.e. use views taken from plenoptic images captured by multiple plenoptic imaging systems). Alternately, the processing module can access more than one plenoptic image from a single plenoptic imaging system (i.e. use views taken from multiple plenoptic images captured by a single plenoptic imaging system). In yet another alternative, the processing module can access one plenoptic image from a single plenoptic imaging system (i.e. use multiple views taken from a single plenoptic image captured by a single plenoptic imaging system).

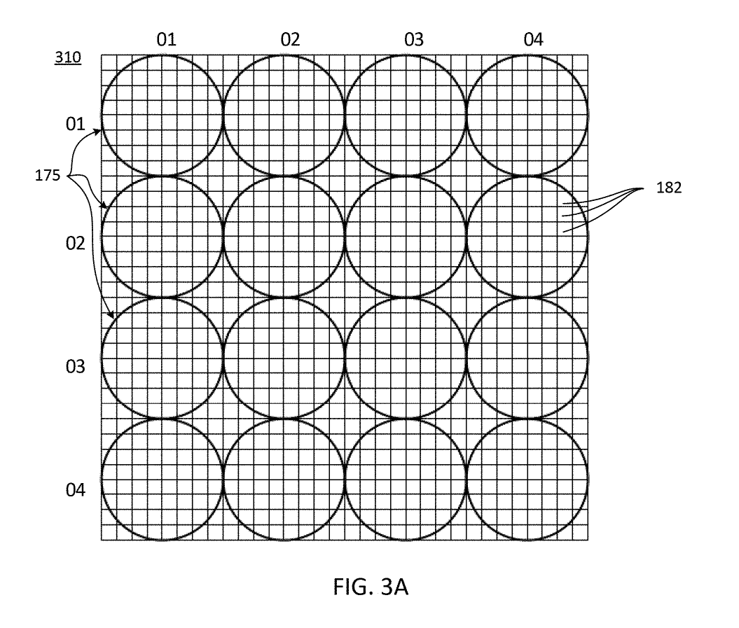

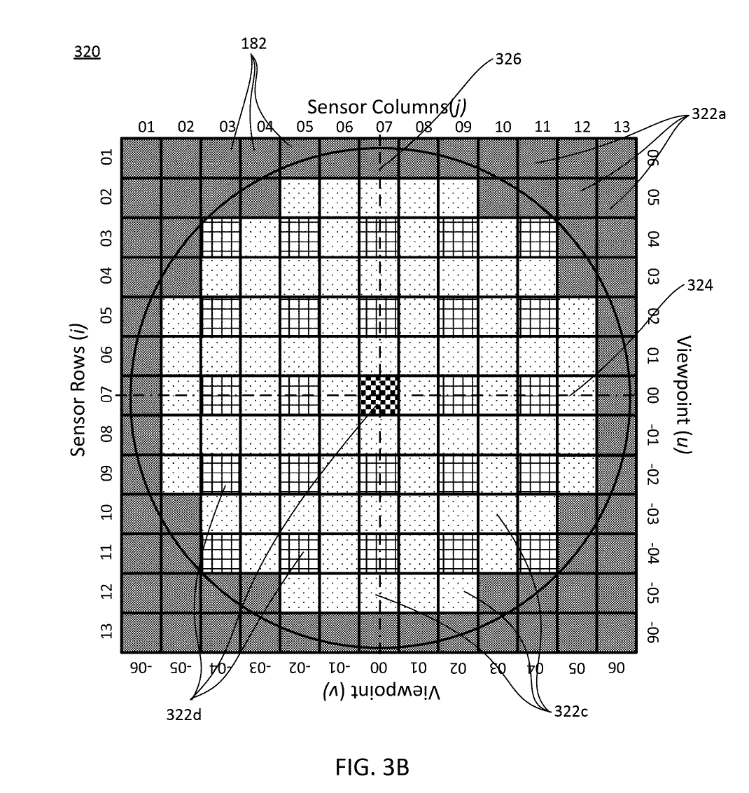

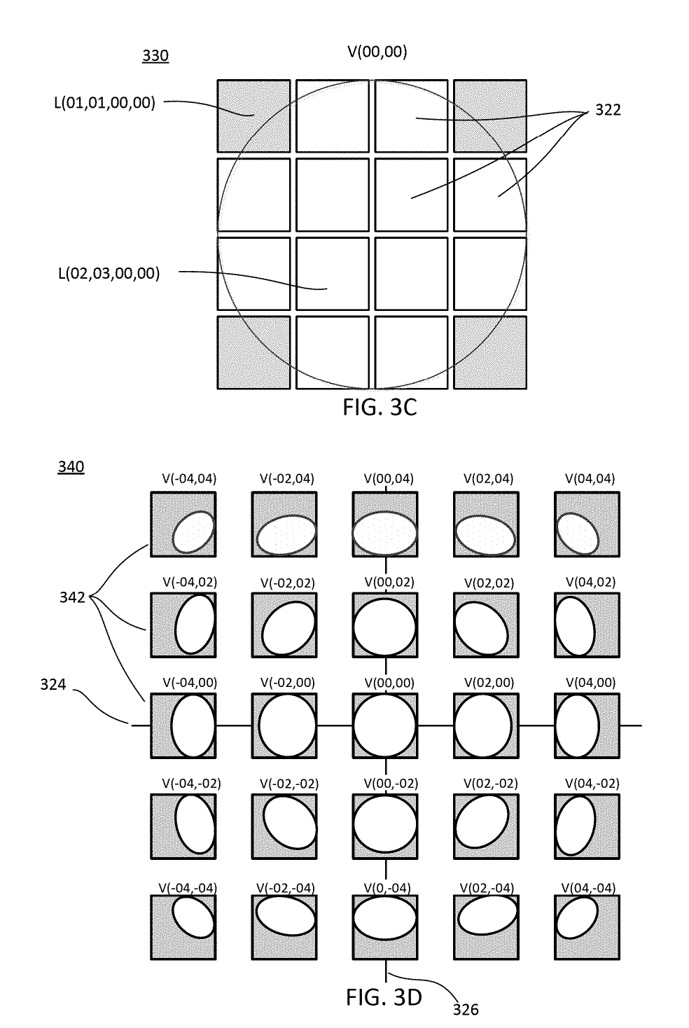

FIGS. 3A-3D are illustrations of a plenoptic image, a superpixel, an image of a single view, and a variety of different views, respectively. FIG. 3A is an illustration of a plenoptic image 310 captured by a plenoptic imaging system. The plenoptic image 310 has multiple superpixels 175. In FIG. 3A, these superpixels are largely round (as opposed to the square superpixels shown in FIG. 1) because the pupil for the primary optics 112 is round. As previously described, each superpixel 175 captures light from a certain viewing region (x,y) of the object. FIG. 3A also shows indices 01-04 in both x and y for the superpixels 175. The upper left superpixel 175 may be referred to as superpixel (01,01). It collects light from a corresponding viewing region of the object, which will be referred to as viewing region (01,01). Each square in FIG. 3A represents a sensor 182 in the sensor array, or a corresponding pixel in the plenoptic image.

FIG. 3B is an illustration of a single superpixel from the plenoptic image of FIG. 3A. For example, this might be the superpixel (01,01), which collects light from viewing region (01,01) of the object. Each square in FIG. 3B represents a sensor in the sensor array or a pixel in the superpixel (01,01). Each pixel corresponds to a light-field viewing direction within a superpixel. The darker gray pixels 322a are vignetted, i.e. receiving less light due to the optical configuration of the plenoptic imaging system. The lighter pixels 322b within the circular vignetting boundary are pixels that are not vignetted, and the crosshatched pixels 322c are pixels that will be used in FIGS. 3C-3D.

Physically, each pixel 322 of the superpixel 175 is associated with a sensor 182 in the sensor array and corresponds to a particular viewpoint of the object. For example, the central pixel is located at the sensor S(07,07) and corresponds to the viewpoint (00,00). That is, the central pixel collects light from the viewing region (02,02) of the object and from the viewpoint (00,00). Extending this pixel into the lightfield notation described above, i.e. L(x,y,u,v), if the superpixel of FIG. 3B is the superpixel (01,01) from the top left of FIG. 3A, then the indices for the lightfield amplitude at this pixel for this superpixel is L(01,01,00,00), where the first two indices indicate the superpixel or viewing region, and the last two indices indicate the viewpoint.

Additionally, each superpixel can include an axis or axes of symmetry, e.g. the horizontal axis 324 and vertical axis 326 of FIG. 3B. Physically, the view axes split the superpixel into symmetric halves. In some embodiments, the view axes may be an axis represented by a line between two columns or rows of sensors. More generally, pixels and views of the plenoptic image can be symmetric about these axes.

To expand on this, FIG. 3C is an image of a single view 330 of a plenoptic image. Note that FIG. 3B and FIG. 3C are not the same. FIG. 3B shows one superpixel and each square in FIG. 3B represents a pixel taken from a different viewpoint. That is, FIG. 3B shows L(x₀,y₀,u,v) for a given x₀,y₀. In contrast, each square 322 in FIG. 3C is a pixel taken from a different superpixel, but which all have the same viewpoint. For example in FIG. 3C, the central pixel for viewpoint (00,00) from all of the superpixels of the plenoptic image 310 of FIG. 3A are used to form the image of the light-field viewing direction (u,v)=(00,00). Using the plenoptic image of FIG. 3A, the generated image of the view can be represented as Im=Σ_{x,y=1}^{x,y=4}L(x, y, u=0, v=0) where the summation is used to select the pixels (i.e. sensors) associated with the viewpoint (00,00) from among the superpixels of FIG. 3A to generate the image rather than summing the luma values of each pixel. That is, FIG. 3C shows L(x,y,u₀,v₀) for a given u₀ and v₀. The pixels 322 in FIG. 3C are not physically adjacent to each other on the sensor array. Rather, the image shown in FIG. 3C is assembled from the plenoptic image by the processing module 190. Further, in the example of FIG. 3C, the imaging optics 112 of the plenoptic imaging system 110 have a high numerical aperture. The large numerical aperture increases the vignetting at the corners of single views, resulting in a more circular view as shown in FIG. 3C rather than a more square view.

The notation V(u₀,v₀) will be used to refer to a view, where (u₀,v₀) indicates the viewpoint (and light-field viewing direction) for that view. That is, V(u₀,v₀) is shorthand for the image L(x,y,u₀,v₀). V(u₀,v₀) is the image (or view) of the object taken from the viewpoint (u₀,v₀). These images generally will use the pixels associated with a viewpoint from all of the superpixels. However, in some embodiments, pixels from less than all of the superpixels are used to generate the views. In FIG. 3C, the view is denoted by L(x,y,00,00)=V(00,00). The view shown in FIG. 3C shows 4×4 pixels, but the circle in FIG. 3C shows the vignetting boundary. Pixels outside the boundary are vignetted. Therefore, V(00,00) includes the 12 white pixels but not the four gray corner pixels. The number of pixels can be increased such that the vignetting boundary can be approximated with a finer granularity. This can be useful if deviations from the reference condition cause the vignetting boundary to shift. Smaller pixels along the boundary will be more sensitive to this deviation.

To continue, FIG. 3D illustrates several different views constructed from the plenoptic image of FIG. 3A. The central view V(00,00) is illustrated in the center of FIG. 3D. The central view is an image of the object taken from the central viewpoint (00,00). Each view V(u,v) is generated from pixels 322c,d in FIG. 3B that correspond to a light field viewing direction (i.e., viewpoint) across all viewing regions (i.e. superpixels) in the plenoptic imaging system. Horizontal 324 and vertical 326 axes of symmetry are also illustrated.

Returning to FIG. 2, the processing module 190 accesses 220 a first view and a second view of a calibration object. These accessed 220 views are from the accessed 210 plenoptic image(s). The two selected views would have a known relationship if the plenoptic imaging system were in a reference condition.

There can be a variety of reference conditions and corresponding known relationships between the selected views, depending on the application. One example application is to test for misalignment of the plenoptic imaging system. The reference condition is then a plenoptic imaging system in which the imaging optics, microlens array, and/or the image sensor array are well aligned. Another example may test for manufacturing or assembly errors, and the reference condition is a plenoptic imaging system without these errors. A final example may test for changes in power performance, such as degradation in power performance due to deterioration of light sources or reduced transmission of optical elements. In that case, the reference condition may be a benchmark of the power performance of the plenoptic imaging system at a specific time so that deterioration relative to the benchmark may be determined.

The specific known relationship between two views will also depend on the application, the views being compared and the calibration object. Examples of known relationships are those based on identity or symmetry, based on distance to the calibration object, or based on known temporal characteristics.

The following are a few examples of known relationships. If the two views are taken from the same or symmetric viewpoints, the known relationship may be that the two views themselves would be the same or symmetric under the reference condition (e.g., if the calibration object and plenoptic imaging system are also same or symmetric in the same manner). For example, the two views may be top-bottom symmetric if they are taken from viewpoints that are top-bottom symmetric about a first view axis (e.g. a horizontal axis). Similarly, the two views may be symmetric if taken from viewpoints that are right-left symmetric about a second view axis (e.g. a vertical axis), or from viewpoints that have two fold rotational symmetry about the first and second axes (e.g. the horizontal and vertical axis). For convenience, the term “same/symmetric” will be used to mean both same and symmetric.

Other than same/symmetric, the views considered may have other relationships. For example, they may be taken from the same/symmetric viewpoints, but with the calibration object located at different distances. As another example, they may be taken from the same/symmetric viewpoints and with the calibration object located at a fixed distance, but taken at different times.

FIG. 3D can be used to illustrate some examples. For example, the two views may be V(00,04) and V(00,04), but captured at different times. Views V(−04,04) and V(−04,−04) are taken from top-bottom symmetric viewpoints, views V(−04,04) and V(04,04) are taken from left-right symmetric viewpoints, and views V(04,04) and V(−04,04) are taken from two-fold rotationally symmetric viewpoints.

Returning to FIG. 2, the processing module 190 determines 230 a measure of divergence of the selected views from the known relationship. The measure of divergence reflects a difference between the current condition of the plenoptic imaging system and the reference condition. This determination can include comparing the two views. In some embodiments, the views are analyzed and compared in energy space with a cost function. One cost function (CF₁) can be a luma differentiator such as a sum of absolute differences:

CF₁=Σₓ^{Res}^{_{X}}Σ_{y}^{Res}^{_{Y}}|Im(y,x)−Im₂(y,x)| (1)

where Im₁(y,x) and Im₂(y,x) are the two views being compared and Res_{X} and Res_{Y} are the number of pixels in each view in the x and y direction, respectively. That is, the summation is over the pixels in the two views. Another cost function (CF₂) can be a correlation co-efficient function

$${CF}_{2} = \frac{{\sum }_{x}^{{Res}_{X}} {\sum }_{y}^{{Res}_{Y}} ( {Im}_{1} ( y , x ) - \overline{{Im}_{1}} ) ( ( {Im}_{2} ( y , x ) - \overline{{Im}_{2}} )}{\sqrt{( {\sum }_{x}^{{Res}_{X}} {\sum }_{y}^{{Res}_{Y}} {( {Im}_{1} ( y , x ) - \overline{{Im}_{1}} )}^{2} ) ( {\sum }_{x}^{{Res}_{X}} {\sum }_{y}^{{Res}_{Y}} {( {Im}_{2} ( y , x ) - \overline{{Im}_{2}} )}^{2} )}} \qquad ( 2 )$$

where I̅m̅₁̅ and I̅m̅₂̅ are the average values for the first and second views.

In the above examples, if the two views are expected to be the same (or could be made the same after accounting for symmetry), then the cost function measures the divergence of the actual views compared to the views under the reference condition. In some instances, the values of the cost functions can be compared against a nominal value when the plenoptic imaging system is in the reference condition. Alternatively, the relative difference between the determined value of the cost function can be compared against the nominal value, the comparison then being the measure of divergence from the reference condition, e.g. the nominal value is 5 and the determined value is 26.8 yielding a measure of divergence of 21.8. In other embodiments, solely the determined value of the cost function can be used as the measure of divergence.

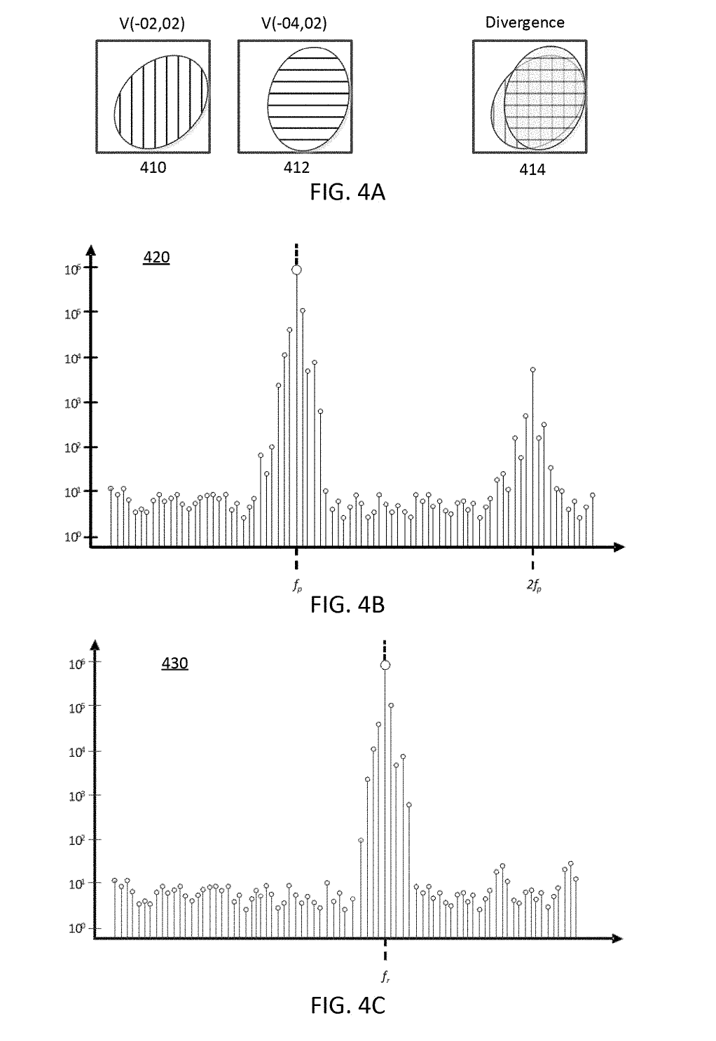

To illustrate this, FIG. 4A is a visualization of a sum of absolute differences cost function calculation for two views from FIG. 3D. The first view 410, i.e. V(−02,02), is compared to the second view 412, i.e. V(−04,−02,) using one of the cost functions. The processing module determines a measure of divergence by calculating the difference between the luma values of the first and second views (that difference shown as the third view 414) resulting in a value representing a measure of divergence.

In other configurations, the measure of divergence can compare the two views images in frequency space. For example, a fast Fourier transform F(c,d) can be applied to each of the two views:

$$F ( c , d ) = {\sum }_{x = 0}^{M - 1} {\sum }_{y = 0}^{N - 1} f ( x , y ) exp [ - 2 π i ( \frac{xd}{M} + \frac{yd}{N} ) ]$$

where each view is an M×N image f(x,y). In this case, the Fourier responses can be analyzed for a dominant frequency and its magnitude. In some examples, more than one dominant frequency and magnitude can be analyzed for each analysis of the Fourier responses. The Fourier responses including the dominant frequencies and magnitudes can be compared between the two views. The measure of divergence between the views is a measure of the dissimilarity between the two Fourier responses, which may include dominant frequency shifts, decays in frequencies, secondary dominant frequencies, etc. For example, the measure of divergence can be a shift in the dominant frequency of 100 Hz, a decay of the magnitude of dominant frequency power by 20%, or an additional dominant frequency.

To illustrate this, FIG. 4B shows the Fourier response 420 of a first view 410 and FIG. 4C shows the Fourier response 430 of a second view 412 (shown in one dimension for ease of explanation). In this example, the first Fourier response has a dominant frequency at fₚ and the second Fourier response has a dominant frequency at fᵣ. The dominant frequency has shifted and decreased in magnitude. This difference can be associated with a value representing the measure of divergence.

The described approaches for determining 230 measures of divergence are only examples of determining the measure of divergence between two views in frequency and energy space. The measure of divergence can use any method to compare two views captured by a plenoptic imaging system. For example, the structural similarity index, mean squared error, and peak signal to noise ratio can be used.

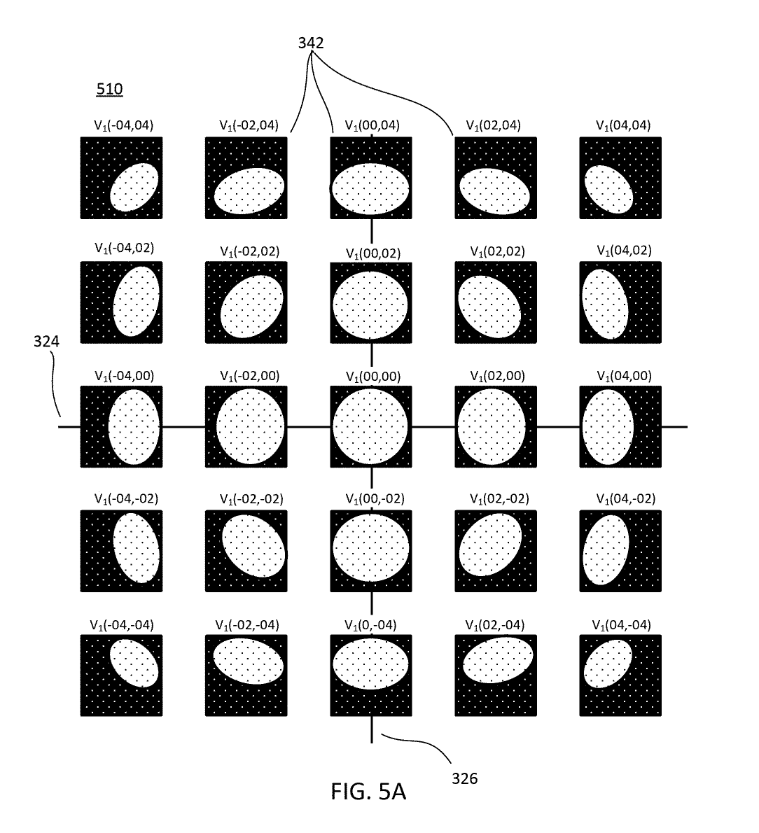

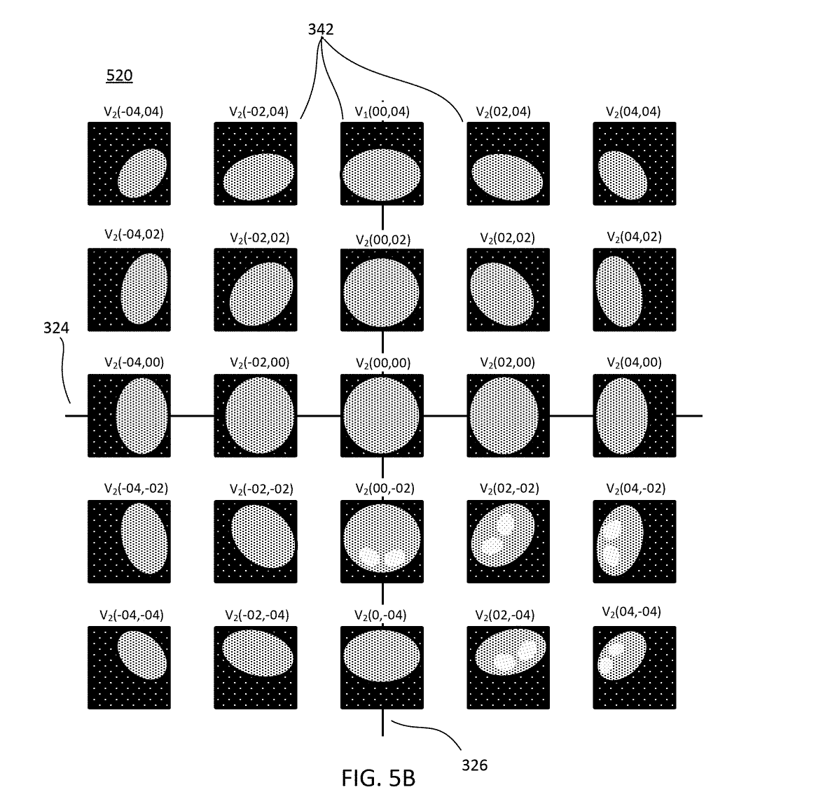

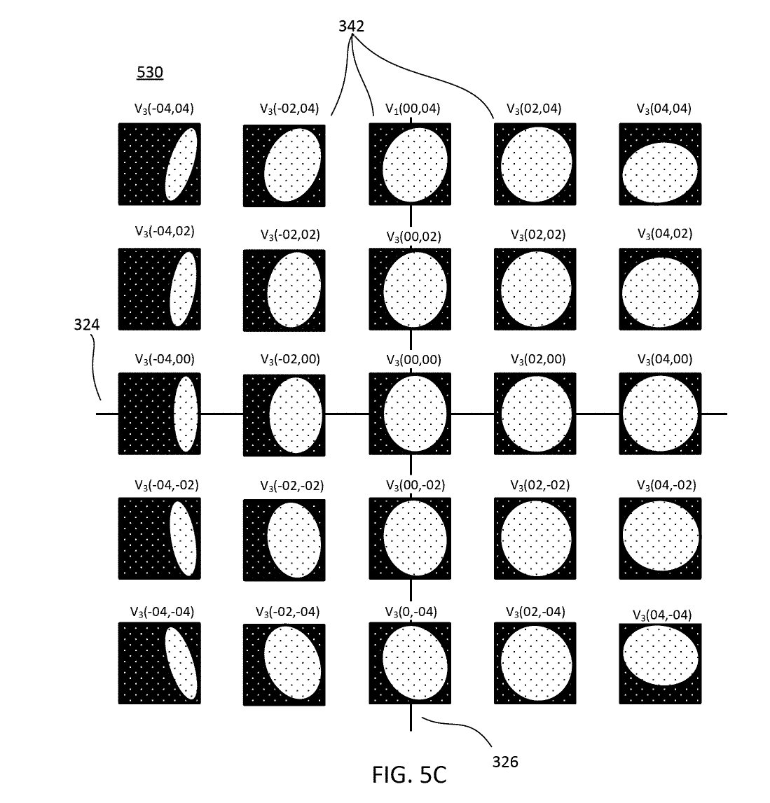

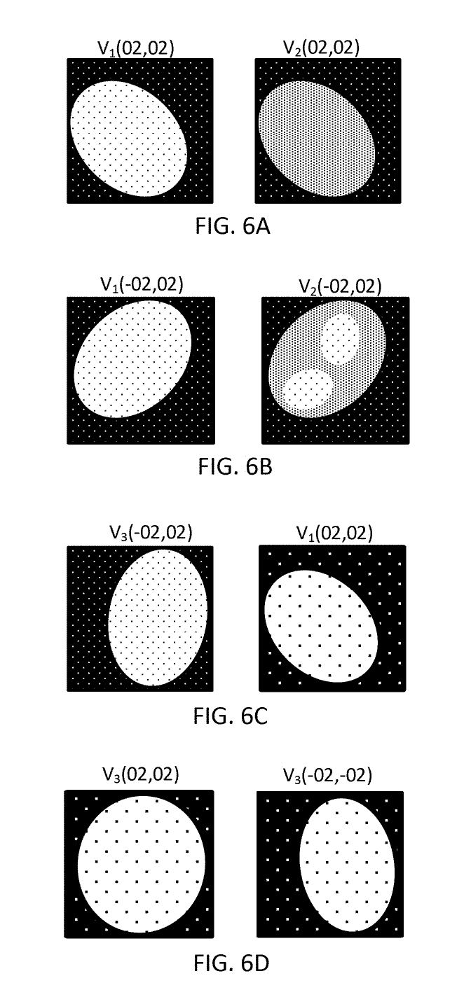

A few more examples are presented in FIGS. 5-6. FIGS. 5A-5C illustrate views 342 from three different plenoptic images. The first plenoptic image 510 of FIG. 5A are views (V₁(u,v)) with the plenoptic imaging system in a reference condition. The views of FIGS. 5B and 5C are views (V₂(u,v) and V₃(u,v), respectively) with the plenoptic imaging system deviating from the reference condition. Similarly to FIG. 3D, the views of FIGS. 5A-5C have a horizontal axis of symmetry 324 and a vertical axis of symmetry 326.

FIGS. 6A-6D illustrate four more examples based on views selected from the plenoptic images of FIGS. 5A-5C. In FIG. 6A, the selected views V₁(02,02) and V₂(02,02) are images from the same viewpoint of different plenoptic images when imaging the same calibration object at a fixed distance. For example, the views may be captured at different times. The application is to monitor power performance and the views should be the same if there is no power performance degradation. In this case, divergence from the reference condition is caused by decaying of a light source. The processing module 190 determines the measure of divergence based on the comparison of the first view and the second view in energy and/or frequency space, for example as described in FIGS. 4B-4C. In some configurations, the processing module 190 can also include the relative decrease in the power of the light source (e.g. the light source has decayed 60% from the reference condition).

In FIG. 6B, the selected views V₁(−02,02) and V₂(−02,02) are images from the same viewpoint of different plenoptic images when imaging the same calibration object (e.g. a white card) at different distances. The application is to detect misalignment and the views should be the same if the plenoptic imaging system is aligned. In this case, the divergence from the reference condition is caused by a misalignment of the components within the plenoptic imaging system. The processing module determines the measure of divergence from the reference condition based on the comparison of the views of the first view and the second view in energy and frequency space. Based on the divergence, the processing module can indicate that there is a misalignment within the plenoptic imaging system. In some configurations, the processing module can determine a relative rotation of the imaging optics between the views (e.g. the microlens array has rotated 3°).

In FIG. 6C, the selected views V₃(−02,−02) and V₁(02,02) are images from symmetric viewpoints of different plenoptic images when imaging the same calibration object at a fixed distance. The application is to detect misalignment and the views should also be symmetric if the plenoptic imaging system is aligned. In this case, the divergence from the reference condition is caused by a misalignment of the imaging optics of the plenoptic imaging system. Similarly to the previous cases, the processing module determines the measure of divergence from the reference condition based on the comparison of the views in energy and frequency space.

FIG. 6D is similar to FIG. 6C, but a different type of symmetry is used and views V₃(02,02) and V₃(−02,−02) from the same plenoptic image are used. In this example, the selected views have two fold rotational symmetry.

These cases are meant only as examples, but any number of views from any number of plenoptic images can be compared to determine the measure of divergence. In one embodiment, determining the measure of divergence from the reference condition can include comparing more than two views or multiple pairs of views, all with similar or different known relationships when in the reference condition. For example, the plenoptic imaging system may choose four views and compare the views using their known relationships.

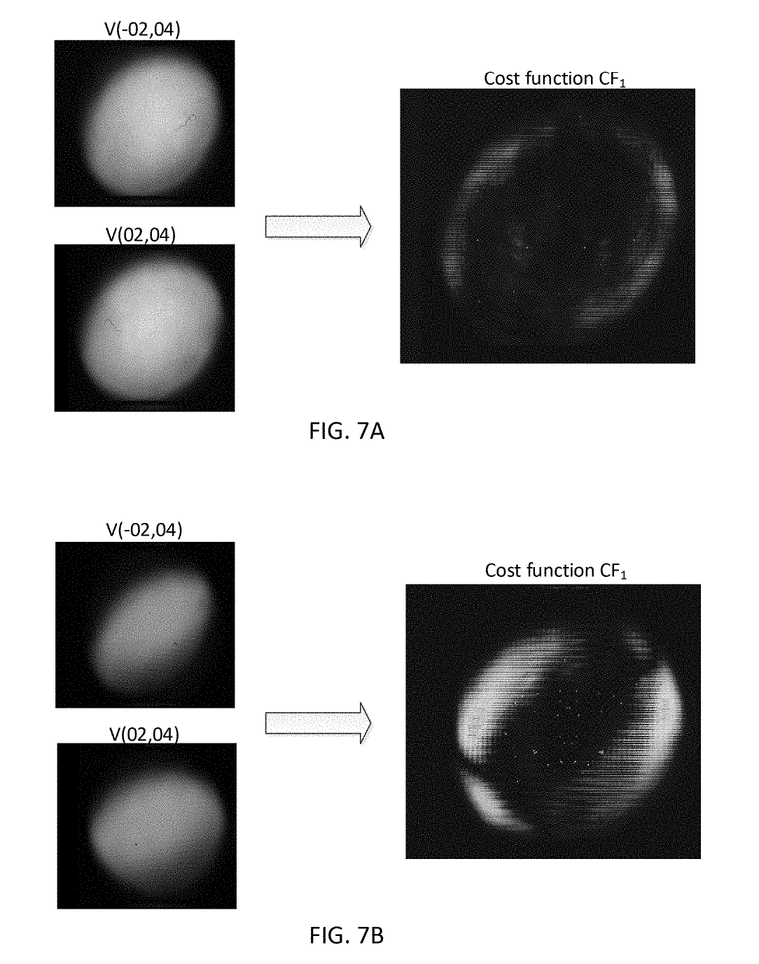

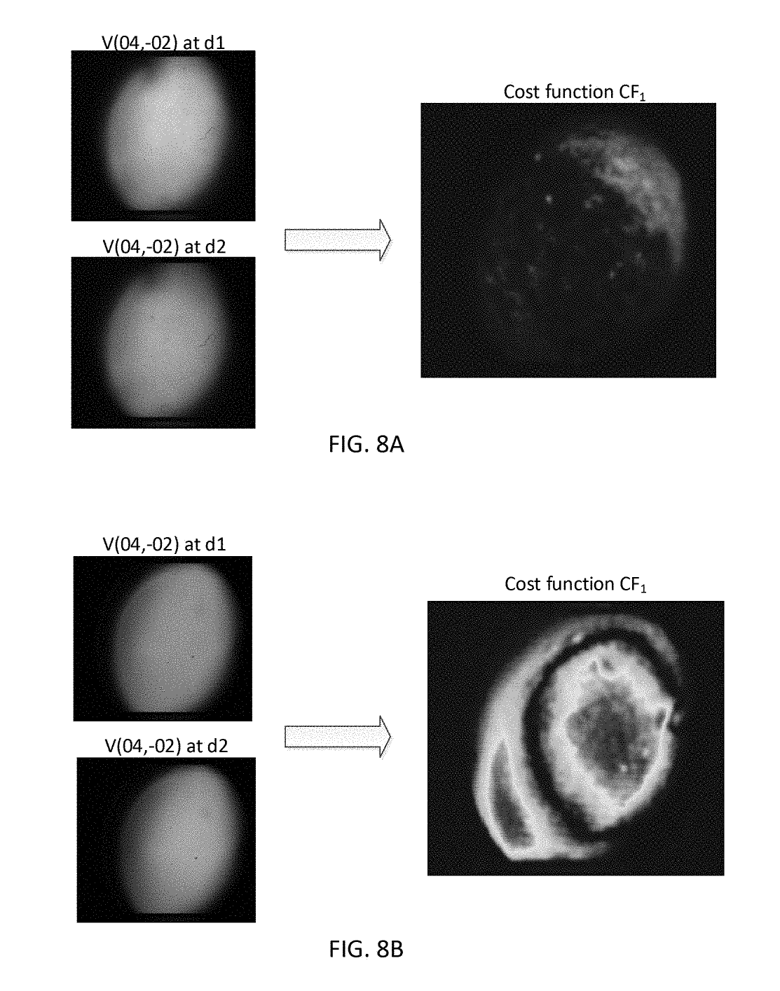

FIGS. 4-6 are diagrams used to illustrate various concepts. FIGS. 7-8 show examples from experiments. In these examples, the plenoptic imaging system has an approximately 250×270 microlens array, and there are approximately 13×13 sensors under each microlens of the microlens array. Thus, the plenoptic imaging system produces an array of 13×13 views, which are indexed from −06 to +06. In FIG. 7, the two views being compared are views V(−02,04) and V(02,04). These views are taken from viewpoints that are right-left symmetric. Therefore, the two views should also be right-left symmetric if the plenoptic imaging system is in alignment. FIG. 7A shows the two views when the plenoptic imaging system is in alignment. V(02,04) is already flipped to facilitate easier comparison. The two views are compared, for example using the cost functions CF₁ or CF₂ defined above. FIG. 7A also shows a pseudo-color image of the cost function CF₁, which shows little difference between the two views. FIG. 7B uses the same format as FIG. 7A, but shows images for a situation when the plenoptic imaging system is misaligned. Specifically, the primary optics is translated in the x direction (along the direction of symmetry) relative to the rest of the plenoptic imaging system. The difference in cost function CF₁ is readily apparent. Numerically, CF₁ is 5.83 for the aligned system and 24.38 for the misaligned system. CF₂ is 0.939 for the aligned system and 0.807 for the misaligned system.

FIG. 8 shows another example for detecting misalignment. Again, FIG. 8A shows two views for an aligned system and the corresponding cost function CF₁. FIG. 8B shows the same two views but for a misaligned system and the corresponding cost function CF₁. In this example, the two views V(04,−02) are taken from the same viewpoint, but the object is located at different distances d₁ and d₂. Preferably, one distance is on one side of the focus point and the other distance is on the other side of the focus point. Because the calibration object is a uniform white object, the two views should be the same for the two distances. However, if there is misalignment, the two views will differ in part because view V(04,−02) is on the vignetting boundary. In this example, CF₁ is 3.70 for the aligned system and 17.93 for the misaligned system, and CF₂ is 0.956 for the aligned system and 0.828 for the misaligned system.

In another embodiment, the processing module may select views of higher quality than others. For example, some views may be less desirable if some of the view lies in an area of the superpixel that is being vignetted. In still other examples, the processing module may select views known to have fewer dead or damaged pixels. Further, the processing module may select views proximal to a vignetting boundary between non-vignetted and vignetted views. The processing module may select views next to the vignetting boundary as these views may be more sensitive to deviations from the reference condition.

In still another embodiment, the processing module may access views and/or determine a measure of divergence as part of a calibration procedure. In one example, the elements of the method of FIG. 2 are executed as part of a pre-use calibration process for the plenoptic imaging system. In another example, any elements of the method of FIG. 2 can be executed as part of an auto-calibration process for the plenoptic imaging system. In a final example, any elements of the method of FIG. 2 can be initiated by a user of the plenoptic imaging system as a real time procedure. In general, the calibration procedures store a plenoptic image, in the system memory and at least one view is accessed from the stored plenoptic image to compare to a subsequently accessed plenoptic image. Alternatively or additionally, the plenoptic imaging system can store views, known relationships, and measures of divergence in the system memory.

Returning to FIG. 2, the processing module 190 indicates 240 a variation from the reference condition based on the determined 230 measure of divergence and the known relationship between the first view and second view. The shape and amplitude of the measure of divergence (e.g. the cost functions) can be used to determine the variation. The indicated variation can describe the type or amount of change of the current condition of the plenoptic imaging system from the reference condition of the plenoptic imaging system, or it can signal merely the existence of divergence from the reference condition. For example, the variation can describe the type of misalignment of the primary imaging optics, the microlens array, or the image sensor (i.e. plenoptic imaging elements). Some examples of the type of misalignment can be: relative rotation between plenoptic imaging elements (e.g. the microlens array is rotated relative to the image sensor), rotation of imaging elements about the primary imaging axis (e.g. a rotation of the primary imaging optics), translation of imaging elements about the primary imaging axis (e.g. translation of the image sensor). In some configurations, the variation can more specifically describe the type of misalignment based on the variation, the selected views, and the known relationships. For example, some more specific misalignment indications can be: the axis of misalignment of an imaging element (e.g. the primary imaging optics are rotated about the x-axis), the degree of rotational misalignment of an element (e.g. the primary imaging optics are rotated about the y-axis by 5°), or the degree of translational misalignment (e.g. the microlens array is translated by 35 μm), or any other variation or combination of variations.

In another configuration, indication 240 of the variation can describe the amount of deterioration of elements of the plenoptic imaging system. Some examples of the deterioration of elements can be: damaged or dead sensors of the image sensor array, decay in response of the image sensor array, or decay of the light source of the plenoptic imaging system. Similarly to misalignment, the variation can more specifically describe the decay of elements based on the variation, the selected views, and the known relationships. For example, some more specific decay indications can be: the number or increase of dead sensors (e.g. an additional 5 dead sensors), the decay of maximum signal intensity of the sensor array (e.g. a 5% reduction of maximum image sensor capability), or the relative decay of the light source from the reference condition (e.g. a 50% reduction of light signal). More generally, the variation can include the degradation in power performance of the plenoptic imaging system.

In some embodiments, this indication of a variation from the reference condition can indicate manufacturing errors, system power degradation over time, sudden misalignment of the plenoptic imaging system (e.g. dropping or breaking), misalignment or relative misalignment of imaging elements over time, etc. For some of these examples, the plenoptic imaging system can indicate to a user (via a feedback system of the plenoptic imaging system such as an icon, a notification, indicator lights, or a message) the variation from the reference condition or if the variation from the reference condition is above a threshold. In some configurations, in response to the variation from the reference condition being above a usable threshold, the plenoptic imaging system may prevent further operation of the system.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. For a plenoptic imaging system that simultaneously captures a plurality of views of an object, the views taken from different viewpoints, a method for determining a condition of the plenoptic imaging system, the method comprising:
accessing a first view and a second view of a calibration object captured by the plenoptic imaging system, wherein the first view and the second view would have a known relationship if the plenoptic imaging system were in a reference condition;
determining a measure of divergence of the first and second views from the known relationship; and
indicating a variation from the reference condition based on the measure of divergence.

2. The method of claim 1, wherein the first and second views are views of the calibration object at a fixed distance, the first and second views are taken from symmetric viewpoints and would be symmetric images if the plenoptic imaging system were in the reference condition, and divergence of the first and second views from symmetry indicates a variation of the plenoptic imaging system from the reference condition.

3. The method of claim 2, wherein the symmetric viewpoints are corresponding right-left viewpoints or corresponding top-bottom viewpoints, and the first and second views would have right-left symmetry or top-bottom symmetry if the plenoptic imaging system were in the reference condition.

4. The method of claim 2, wherein the symmetric viewpoints are symmetric about a center viewpoint, and the first and second views would have two-fold rotational symmetry if the plenoptic imaging system were in the reference condition.

5. The method of claim 2, wherein the first and second views are different views from a single plenoptic image.

6. The method of claim 1, wherein the first and second views are views of the calibration object at different distances, the first and second views are taken from same/symmetric viewpoints, the first and second views would be same/symmetric images if the plenoptic imaging system were in the reference condition, and divergence of the first and second views from same/symmetric images indicates a variation of the plenoptic imaging system from the reference condition.

7. The method of claim 1, wherein the first and second views are views of the calibration object at a fixed distance, the first and second views are taken from same/symmetric viewpoints but at different times, the first and second views would have a same energy if the plenoptic imaging system were in the reference condition, and differences in energy profile between the first and second views indicate a variation of the plenoptic imaging system from the reference condition.

8. The method of claim 7, wherein the first view was taken before the second view, the first view is stored in a memory of the plenoptic imaging system, and determining a measure of divergence of the first and second views comprises retrieving the first view from the memory.

9. The method of claim 1, wherein the first and second views are proximal to a vignetting boundary for the plenoptic imaging system.

10. The method of claim 1, wherein the plenoptic imaging system comprises imaging optics, a microlens array and a sensor array, and variation from the reference condition includes a misalignment of the imaging optics or a misalignment of the microlens array relative to the sensor array.

11. The method of claim 1, wherein variation from the reference condition includes manufacturing and assembly errors in the plenoptic imaging system.

12. The method of claim 1, wherein variation from the reference condition includes degradation in power performance of the plenoptic imaging system.

13. The method of claim 1, wherein determining the measure of divergence comprises comparing the first and second views in frequency space.

14. The method of claim 1, wherein determining the measure of divergence comprises comparing a measure of energy of the first and second views.

15. The method of claim 1, further comprising:
accessing pairs of a first view and a second view of a calibration object captured by the plenoptic imaging system, wherein the first view and the second view of each pair would have a known relationship if the plenoptic imaging system were in the reference condition; and
determining the measure of divergence of all of the first views and second views from the known relationship.

16. The method of claim 1, wherein the method is executed as part of a pre-use calibration process for the plenoptic imaging system.

17. The method of claim 1, wherein the method is executed automatically by the plenoptic imaging system as part of an auto-calibration process for the plenoptic imaging system.

18. The method of claim 1, wherein the method is initiated by a user of the plenoptic imaging system.

19. The method of claim 1, wherein indicating the variation from the reference condition comprises providing a notice to a user of the plenoptic imaging system.

20. The method of claim 1 further comprising:
in response to detecting the variation from the reference condition, preventing further operation of the plenoptic imaging system.
